(19) United States
(12) Patent Application Publication
(10) Pub. No.: US 2026/0251850 A1
(43) Pub. Date: Aug. 27, 2026

(54) Integrated Optical Device and Alignment Method for Integrated Optical Device

(71) Applicant: NTT. INC., Tokyo (JP)

(72) Inventors: Yu Kurata, Musashino-shi, Tokyo (JP); Yoshihiro Ogiso, Musashino-shi, Tokyo (JP); Yasuaki Hashizume, Musashino-shi, Tokyo (JP)

(21) Appl. No.: 18/992,449

(22) PCT Filed: Jul. 14, 2022
(86) PCT No.: PCT/JP2022/027733

§ 371 Date: Jan. 8, 2025

(51) Int. Cl. G02B 6/255

(52) U.S. Cl. CPC G02B 6/2555

(57) ABSTRACT

An integrated optical device includes an optical functional element in which an optical waveguide including a core and a cladding is provided on a substrate, the optical functional element including: an input waveguide or an output waveguide of an optical signal provided on an end face of the substrate; and a reflectance control body that is provided in the vicinity of the core and forms a region having a reflectance different from reflectances of the core, the cladding, and the substrate when light is incident on the end face, and the input waveguide or the output waveguide of the optical functional element is butt-coupled and bonded to another waveguide via the end face.

### TECHNICAL FIELD

The present invention relates to an integrated optical device applicable to an optical communication system, and relates to an optical functional element including an optical waveguide and an integrated optical device on which the optical functional element is mounted.

### BACKGROUND ART

In recent years, with the spread of optical fiber transmission, a technique for integrating a large number of optical circuits at high density is required, and as one of the techniques, a silica-based planar lightwave circuit (hereinafter, referred to as a PLC) and an optical circuit (SiP) by silicon photonics are known. The PLC is a waveguide type optical device having excellent characteristics such as low loss, high reliability, and a high degree of freedom in design, and a PLC in which functions such as a multiplexer/demultiplexer and a branching/coupling device are integrated is actually mounted in a transmission apparatus at an optical communication transmission end. The SiP is an optical device that has a high degree of freedom in design and can achieve a smaller optical circuit with a small waveguide bending radius although the SiP cannot achieve as low loss as the PLC. In addition, as an optical device other than the PLC and the Sip, a photodiode (hereinafter, a PD) that converts light and electric signals, a laser diode (LD) or an optical functional element such as an optical modulator are also mounted in the transmission apparatus. In order to further increase communication capacity, there is a demand for a highly functional optoelectronic integrated device in which an optical waveguide such as a PLC that performs optical signal processing and an optical device such as a PD that is made of an InP-based (indium phosphide-based) material and performs high-speed photoelectric conversion are integrated.

As described above, the PLC and the Sip are promising as a platform for such an integrated optical device, and an integrated optical device in which an InP optical modulator chip and a PLC chip are hybrid-integrated have been proposed (Non Patent Literature 1). In the example of Non Patent Literature 1, a method is adopted in which a phase modulator is integrated on an InP chip, a polarization rotator (PR) and a polarization beam combiner (PBC) are integrated on a PLC, and the both chips are optically coupled via a lens. The method in which the PLC is used as a polarization synthesis chip requires a smaller mounting area than a method in related art in which polarization synthesis is constructed by a spatial optical system, and can simplify optical axis alignment as a result of integration being performed in an optical circuit. Such a mode in which the PLC and an optical circuit element such as the InP are combined and optically coupled is advantageous in terms of downsizing of a device and a degree of freedom in designing the optical circuit, and an integrated device including a PD having a waveguide structure suitable for widening a bandwidth by an InP-based material, an optical phase modulator having a high-speed phase modulation function, and the like, has been developed in order to expand communication capacity. Furthermore, in recent years, an integrated optical device in which optical circuit elements are directly connected to each other without interposition of a lens has been required for further downsizing.

A method in which input/output waveguides of the PLC and the InP-based optical functional element are butt-coupled without interposition of a lens will be described.

For example, in a case where an optical fiber and the PLC are butt-connected, first, an end face of the optical fiber block made of glass to which the optical fiber is fixed and an end face of the PLC end are adjusted to be parallel. Thereafter, while light is input to the optical fiber, a light output position of the optical fiber is adjusted to an input waveguide of the end face of the PLC, and the position is adjusted so as to obtain optimum optical coupling while monitoring output light from an output waveguide connected to the input waveguide. Then, a space between the end face of the optical fiber block and the end face of the PLC is filled with a UV curing adhesive while the position is kept and is cured and fixed in a short period of time by being irradiated with UV light.

If integration of the optical functional element made of Si or InP using the optical circuit of the PLC as a platform or integration of the optical functional element made of InP using SiP as an optical circuit platform can be implemented using such a butt-coupling method, it is possible to provide a more compact integrated optical device. However, for example, in a case where the optical functional element having a U-shaped folded configuration in which the input/output waveguides are arranged on the same end face and the optical circuit element are connected using such a butt-coupling method as illustrated in FIG. 1, there are the following problems.

FIG. 1 is a view illustrating an optical circuit configuration of an integrated optical device in related art. In FIG. 1, a phase modulator chip 110, which is an optical functional element, includes an optical input waveguide 111 and a first QPSK modulation unit 112 and a second QPSK modulation unit 113 that phase-modulate and output signal light from the optical input waveguide 111. In addition, the phase modulator chip 110 includes two optical output waveguides 114 and 115 that output output light from the first and second QPSK modulation units. A polarization Mux chip 120, which is an optical circuit element, includes a signal light input/output waveguide 121, phase modulation optical input waveguides 122 and 123, a polarization Rotator 124 that rotates TE light of the phase modulation optical input waveguide 123 into TM light, and a polarization beam combiner 125 that multiplexes the TE light of the phase modulation optical input waveguide 122 and the TM light from the polarization Rotator 124. The signal light input/output waveguide 121 is connected to the optical input waveguide 111 and outputs input signal light to the optical input waveguide 111. The phase modulation optical input waveguides 122 and 123 are connected to the optical output waveguides 114 and 115, respectively. The signal light from the polarization beam combiner 125 is output from a signal light output waveguide 126.

In order to butt-couple and connect the optical input waveguides 111 and the optical output waveguides 114 and 115 of the phase modulator chip 110 of FIG. 1, the signal light input/output waveguide 121 of the polarization Mux chip 120, and the phase modulation optical input waveguides 122 and 123, it is necessary to align the waveguides to be connected on the connection end face by inputting light into the optical input/output waveguide 121 of the polarization Mux chip 120 and moving a position of the phase modulator chip or the polarization Mux chip on an X-Y plane while monitoring intensity of light output from the signal light output waveguide 126 via the connection end face.

In order to monitor the intensity of light at which an optical signal input via the signal light input/output waveguide 121 propagates to the signal light output waveguide 126 and is output, it is necessary that at least the optical input waveguide 111 and the signal light input/output waveguide 121, the optical output waveguide 114 and the phase modulation optical input waveguide 122, and the optical output waveguide 115 and the phase modulation optical input waveguide 123 are pre-aligned in advance to rough positions where the intensity of the light can be confirmed. In addition, at least two points (three points in FIG. 1) are connected on the same connection face, and thus, alignment of rotation about the Z axis (Z-axis rotation) also needs to be performed with high accuracy. However, in general, in such alignment work, the position on the connection end face (X-Y plane) is adjusted only by observation from an upper surface, and thus, it is difficult to completely match the Z-axis rotation. For this reason, in a case of connection with an optical functional element having a folded configuration such as the phase modulator chip in FIG. 1, it is necessary to gradually perform alignment while repeating fine adjustment of the Z-axis rotation many times. As described above, there is a problem that a complicated alignment process is required in order to implement small integration without a spatial optical system such as a lens by end face connection.

Thus, as illustrated in FIGS. 2 and 3, there has been proposed a configuration in which an input-side alignment through port 215 and an output-side alignment through port 216 are provided in the vicinity of the optical input waveguide 211 and the optical output waveguide 214 of the phase modulator chip 210, which are optical functional elements. FIG. 2 illustrates a state of output-side alignment, and FIG. 3 illustrates a state of input-side alignment. In FIG. 2, input light is input from an output waveguide 226 of the polarization Mux chip 220, and while monitoring output light from the output-side alignment through port 216, the polarization Mux chip 220 or the phase modulator chip 210 is moved in an X-Y direction to perform alignment between a phase modulation optical input waveguide 222 of the polarization Mux 220 and the output-side alignment through port 216 of the phase modulator chip 210. In FIG. 3, input light 229 is input from the signal light input/output waveguide 221 of the polarization Mux chip 220, and while monitoring output light 219 from the input-side alignment through port 215, the polarization Mux chip 220 or the phase modulator chip 210 is moved in the X-Y direction to perform alignment between the signal light input/output waveguide 221 of the polarization Mux 220 and the input-side alignment through port 215 of the phase modulator chip 210. By performing each of the input-side alignment and the output-side alignment, it is confirmed how much the Z-axis rotation deviates from a position of a fine movement table and a movement amount after each alignment. In this manner, the alignment of the Z-axis rotation can be easily adjusted, and the process can proceed to a step of aligning the input/output waveguides of the optical functional element and the optical circuit element without fine adjustment being performed many times.

In addition, as illustrated in FIG. 4, by providing an output-side alignment tap port 411 and an input-side alignment tap port 412 in a phase modulator chip 410, which is an optical functional element, and moving a polarization Mux chip 420 or the phase modulator chip 210 in the X-Y direction to perform the input-side alignment and the output-side alignment, respectively, while monitoring the output light from which the input light input to the polarization Mux chip 220 is output via each tap port, it is possible to confirm a deviation amount of the Z-axis rotation from the position of the fine movement table after the alignment and to perform alignment of the Z-axis rotation.

However, in a case where alignment is performed while a through port or a tap port for alignment is provided in the optical functional element illustrated in FIGS. 2 to 4, it is necessary to separately dispose an optical fiber or a PD at an emission position of output light of the through port or the tap port and perform alignment while monitoring the output light. In addition, there is a problem that setting for alignment is complicated, such as switching between input-side alignment and output-side alignment and installation of optical fibers and PDs. In addition, it is necessary to arrange an optical waveguide circuit for a through port and a tap port in the optical functional element, which leads to a problem that downsizing is hindered. Furthermore, in a case where a tap port for alignment is provided as illustrated in FIG. 4, alignment is performed by tapping part of the signal light, and thus, there is also a problem that loss increases when viewed from a signal light path.

As described above, in a configuration in related art in which a PLC or a SiP is used as a platform, and an optical circuit element in which a polarization control circuit, and the like, are integrated and an optical functional element such as an optical modulator are hybrid-integrated, in order to butt-couple optical waveguides without interposition of a lens, a complicated alignment process and complicated setting are required, which leads to a problem that downsizing is hindered.

### CITATION LIST

### Non Patent Literature

Non Patent Literature 1: E. Yamada et al., “112-Gb/s InP DP-QPSK modulator integrated with a silica-PLC polarization multiplexing circuit”, Proc. Opt. Fiber Commun. Conf. Expo. Nat. Fiber Opt. Eng. Conf., Mar. 2012.

### SUMMARY OF INVENTION

### Technical Problem

The present invention has been made in view of such a problem, and an object of the present invention is to provide an integrated optical device that is applicable to integration of an optical functional element having an optical waveguide input/output structure and an optical circuit element having an optical waveguide input/output structure for inputting/outputting an optical signal to/from the optical functional element, and implements end face optical coupling by a structure that enables simple alignment when an optical signal is input/output between the optical functional element and the optical circuit element by end face connection.

### Solution to Problem

In order to achieve such an object, the present invention includes the following configuration.

### (Configuration 1)

An integrated optical device including an optical functional element in which an optical waveguide including a core and a cladding is provided on a substrate, the optical functional element including:
an input waveguide or an output waveguide of an optical signal provided on an end face of the substrate; and
a reflectance control body that is provided in the vicinity of the core and forms a region having a reflectance different from reflectances of the core, the cladding, and the substrate when light is incident on the end face,
in which the input waveguide or the output waveguide of the optical functional element is butt-coupled and bonded to another waveguide via the end face.

### (Configuration 2)

An alignment method for an integrated optical device including an optical functional element in which an optical waveguide including a core and a cladding is provided on a substrate, and the optical functional element including:
an input waveguide or an output waveguide of an optical signal provided on an end face of the substrate; and
a reflectance control body that is provided in the vicinity of the core and forms a region having a reflectance different from reflectances of the core, the cladding, and the substrate when light is incident on the end face,
the alignment method including:
in alignment for butt-coupling via the end face between the optical functional element and an optical circuit element including an input waveguide or an output waveguide for connection,
monitoring light intensity of reflected return light branched by a circulator or a coupler disposed at an optical input of the optical circuit element; and
performing alignment by estimating correspondence between a scanning position and a position of a region having different reflectance formed by the reflectance control body on the end face from a position at which a profile of the light intensity of the reflected return light in accordance with a cross-sectional shape of the end face becomes a peak by performing scanning while moving the optical functional element or the optical circuit element.

### Advantageous Effects of Invention

According to the present invention, in integration of an optical functional element such as an optical modulator having an optical waveguide input/output structure and an optical circuit element having a polarization control circuit, an optical signal is input/output between the optical functional element and the optical circuit element by butt-coupling between respective waveguides, so that it is possible to provide an optical waveguide component that implements simple and highly efficient optical coupling.

### BRIEF DESCRIPTION OF DRAWINGS

FIG. 1 is a view illustrating an optical circuit configuration of an integrated optical device in related art in which an optical functional element and an optical circuit element having a U-shaped folded configuration in which input/output waveguides are arranged on the same end face are connected by a butt-coupling method.

FIG. 2 is a view illustrating an optical circuit configuration of an integrated optical device in related art in which alignment through ports are respectively provided in the vicinity of optical input and optical output waveguides of an optical functional element.

FIG. 3 is a view illustrating an optical circuit configuration of an integrated optical device in related art in which alignment through ports are respectively provided in the vicinity of optical input and optical output waveguides of an optical functional element.

FIG. 4 is a view illustrating an optical circuit configuration of an integrated optical device in related art in which a tap port for alignment is provided in an optical functional element.

FIG. 5 is a view illustrating an optical circuit configuration of an integrated optical device according to an embodiment of the present invention.

FIG. 6 is a view illustrating an alignment input/output structure of an input/output unit of an optical functional element according to the embodiment of the present invention.

FIG. 7 is a view illustrating a reflected return light intensity profile when reflected return light intensity is scanned while the optical functional element or an optical circuit element of the integrated optical device according to the embodiment of the present invention is moved along an X axis and a Y axis.

FIG. 8 is a view illustrating an optical circuit configuration of an integrated optical device according to Examples, or the like.

FIG. 9 is a view illustrating a relationship between a scanning position of a connection end face of an alignment input/output structure of an optical functional element of Example 1 and a reflected return light intensity profile corresponding to the scanning position.

FIG. 10 is a view illustrating a relationship between a scanning position of a connection end face of an input/output unit of an optical functional element of Comparative Example 1 and a reflected return light intensity profile corresponding to the scanning position.

FIG. 11 is a view illustrating an alignment input/output structure of Example 2.

FIG. 12 is a view illustrating a relationship between a scanning position of a connection end face of the alignment input/output structure of an optical functional element of Example 2 and a reflected return light intensity profile corresponding to the scanning position.

FIG. 13 is a view illustrating an alignment input/output structure of Example 3.

FIG. 14 is a view illustrating a relationship between a scanning position of a connection end face of the alignment input/output structure of an optical functional element of Example 3 and a reflected return light intensity profile corresponding to the scanning position.

FIG. 15 is a view illustrating boundary scanning of the alignment input/output structure of Example 3.

### DESCRIPTION OF EMBODIMENTS

An embodiment of the present invention will be described in detail below with reference to the drawings.

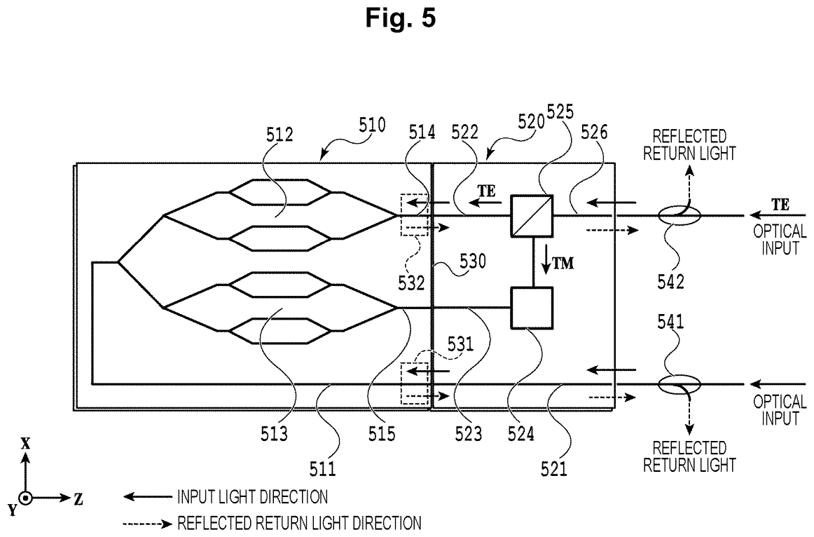

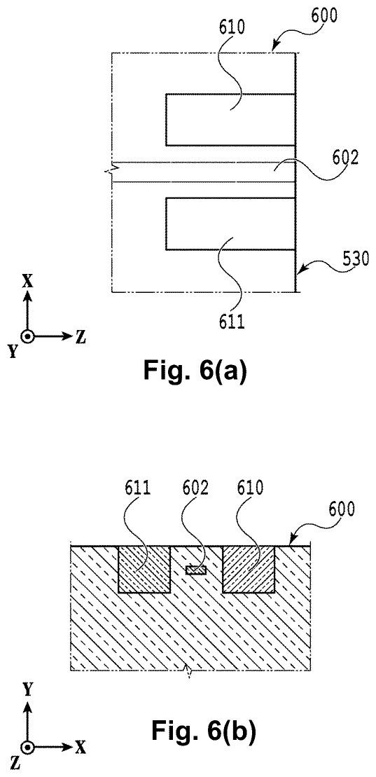

FIGS. 5 and 6 illustrate the embodiment of the present invention for illustrative purposes.

In this embodiment, in an optical functional element in which an optical waveguide is provided on a substrate, an alignment input/output structure including an input waveguide or an output waveguide that inputs or outputs a signal to/from an optical circuit element is provided in the vicinity of one end face of the substrate constituting the optical functional element.

FIG. 5 illustrates an optical circuit configuration of an integrated optical device including a phase modulator chip 510 which is an optical functional element of the present embodiment and a polarization Mux chip 520 which is an optical circuit element.

The phase modulator chip 510, which is an optical functional element, includes an optical input waveguide 511 and a first QPSK modulation unit 512 and a second QPSK modulation unit 513 that phase-modulate and output signal light from the optical input waveguide 511. In addition, the phase modulator chip 510 includes two optical output waveguides 514 and 515 that output output light from the first and second QPSK modulation units. The polarization Mux chip 520, which is an optical circuit element, includes a signal light input/output waveguide 521, phase modulation optical input waveguides 522 and 523, a polarization Rotator 524 that rotates TE light of the phase modulation optical input waveguide 523 into TM light, a polarization beam combiner 525 that multiplexes the TE light of the phase modulation optical input waveguide 522 and the TM light from the polarization Rotator 524, and a signal light output waveguide 526 that outputs light from the polarization beam combiner.

In the present embodiment, alignment input/output structures 531 and 532 are provided in the vicinity of the optical input waveguide 511 and the optical output waveguide 514 on a connection end face 530 side which are input/output units of the phase modulator chip 510, respectively.

FIG. 6(a) is a view of an alignment input/output structure 600 (531 or 532 in FIG. 5) of the present embodiment provided in the input/output unit of the optical functional element as viewed from above, and FIG. 6(b) is a view of the alignment input/output structure 600 of the present embodiment as viewed from the connection end face side. In the alignment input/output structure of the present embodiment, as illustrated in FIG. 6(a) and 6(b), on the connection end face 530 side of the substrate of the optical functional element, reflectance control bodies 610 and 611 that form regions having reflectances different from reflectances of the core 602, the cladding, and the substrate when light is incident on the connection end face are provided in the vicinity of the core 602. Procedure of alignment via the connection end face between the optical functional element and the input/output waveguide for connection of the optical circuit element (polarization Mux chip 520) of the present embodiment is as follows. As illustrated in FIG. 5, a circulator 541, a coupler, or the like, is disposed in the signal light input/output waveguide 521 of the polarization Mux chip 520, which is an optical circuit element, to branch reflected return light, and reflected return light intensity is scanned while moving the optical functional element or the optical circuit element along the X axis or the Y axis. In this event, the intensity of the reflected return light from the end face having the alignment input/output structure including the reflectance control bodies changes according to the structure. Similarly, a circulator 542, a coupler, or the like, is disposed in the signal light output waveguide 526 of the polarization Mux chip 520 to branch reflected return light, and reflected return light intensity is scanned while moving the optical functional element or the optical circuit element along the X axis or the Y axis.

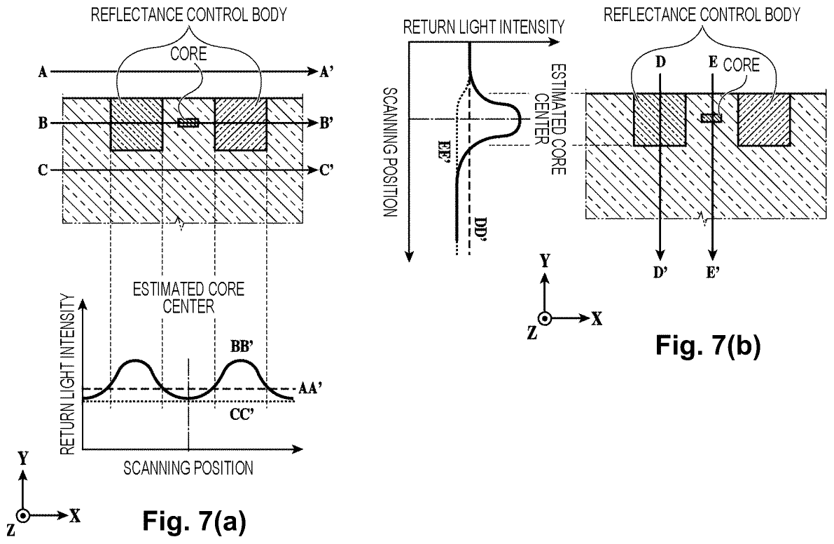

FIG. 7 is a view illustrating a reflected return light intensity profile when the reflected return light intensity is scanned while the optical functional element or the optical circuit element is moved along the X axis and the Y axis as described above. FIG. 7(a) is a view illustrating X-direction scanning and illustrates a reflected return light intensity profile when scanning is performed while moving light from the input/output waveguide of the optical circuit element along the X-axis on a line A-A′, a line B-B′, and a line C-C′.

FIG. 7(b) is a view illustrating Y-direction scanning and illustrates a reflected return light intensity profile obtained by performing scanning while moving light from the input/output waveguide of the optical circuit element along the Y-axis on a line D-D′ and a line E-E′.

As illustrated in FIG. 7(a) and 7(b), the reflected return light intensity profile reflects a structure of the end face including the reflectance control bodies, and the reflected return light intensity increases particularly when an area including the reflectance control body is scanned. As a result, the contrast of the reflected return light intensity at the boundary between the reflectance control body and the other portion increases, so that it is possible to easily estimate a position of the connection end face to which the scanned portion corresponds as a result of the reflectance control body existing.

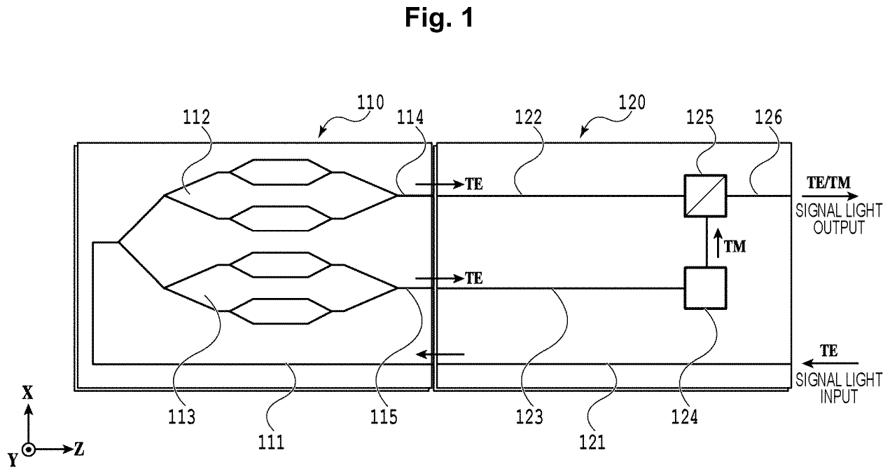

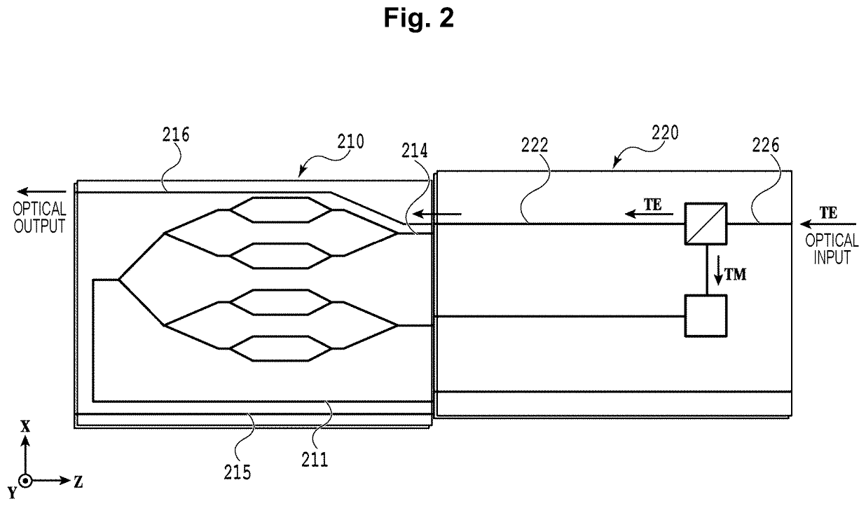

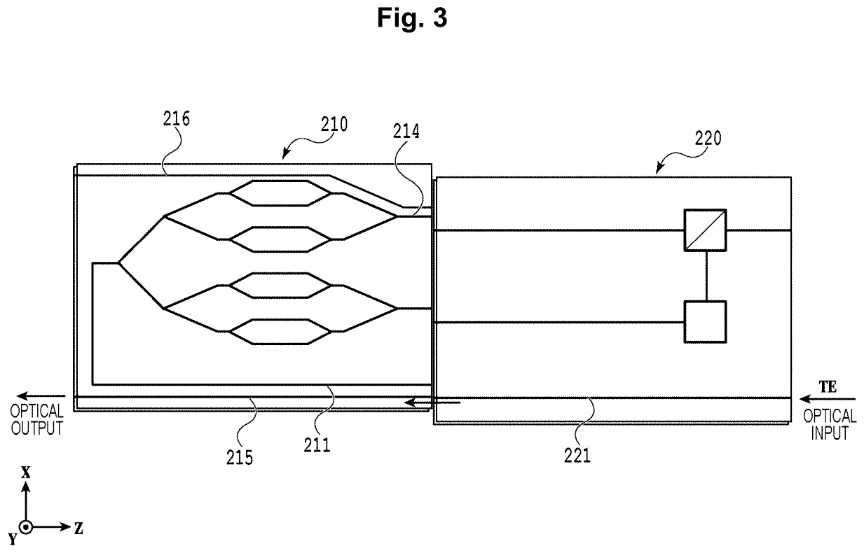

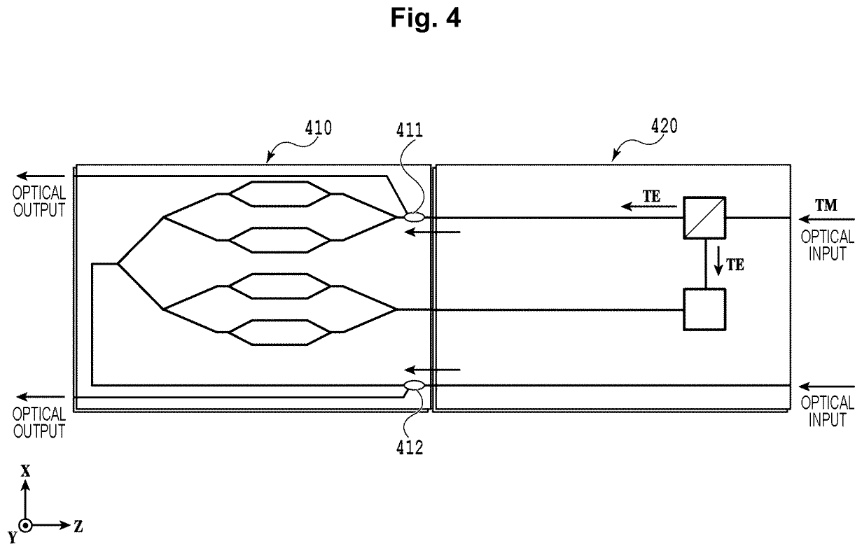

Thus, the input/output waveguide of the optical functional element and the input/output waveguide of the optical circuit element including the alignment input/output structure of the present embodiment can be aligned in advance to positions aligned to such an extent that light can be transmitted between the input/output waveguides to be butt-coupled, including alignment of the Z-axis rotation. Thereafter, the process can continuously shift to more precise alignment to be performed while signal light is input, and output light is monitored as illustrated in FIG. 1. As described above, in the present embodiment, it is possible to perform highly accurate alignment with a simple configuration and procedure without separately preparing an alignment port, or the like, as illustrated in FIGS. 2 to 4. Note that, in this embodiment, the input/output waveguide of the optical functional element has a U-shaped folded configuration in which the optical input waveguide 511 and the optical output waveguide 514 are on the same connection end face 530 side, but may have other configurations. For example, the folded configuration may have a U shape or any other shape as long as a path through which light input to the optical input waveguide is output from the optical output waveguide is formed. In addition, the input or output waveguides of the optical functional element may be on different end faces, or only one of the input or output waveguides of the optical functional element may be provided with the alignment output structure. In addition, using the alignment output structure of the present embodiment, it is also possible to perform only alignment for butt-connecting one of the input and output waveguides of the optical functional element to the waveguide of the optical circuit element. Furthermore, in the present embodiment, a case where the input/output waveguide of the optical functional element and the input/output waveguide of the optical circuit element are butt-coupled has been described, but the waveguide to be butt-coupled with the input/output waveguide of the optical functional element may be a waveguide included in an optical element other than the optical circuit, and the waveguide may be an optical fiber, or the like, in addition to the waveguide formed on the substrate.

As described above, in the embodiment of the present invention, the reflectance control bodies are provided in the vicinity of the core of the input/output waveguide as the alignment input/output structure in the optical functional element. Then, the light from the input/output waveguide of the optical circuit element is radiated to the connection end face of the optical functional element provided with the reflectance control bodies, and the end face shape and the position of the core can be easily estimated by using the reflected return light intensity profile having the intensity corresponding to the reflectance of the irradiation position. In addition, in this embodiment, the return light intensity profile is used, and thus, it is not necessary to separately provide an alignment port, or the like, in the optical functional element as in the example in related art of FIGS. 2 to 4.

Then, in a case where the waveguide is butt-coupled to the input/output waveguide of the optical functional element including the alignment input/output structure of this embodiment, it is possible to pre-align the positions of the waveguides to be butt-coupled in advance to positions where more precise alignment can be performed while signal light is input, and an output is monitored.

In addition, in connection with the optical functional element including the alignment input/output structure of the present embodiment, prior to precise alignment, rough alignment including rotational alignment around not only the X-Y direction but also the Z axis is performed in advance. Thus, fine adjustment is unnecessary in the subsequent fine alignment, which can shorten an alignment period.

In general, the PLC has a cross-sectional structure in which a thin film of SiO₂ is deposited on a substrate of Si or SiO₂ by about 20 μm as an undercladding, 3 to 10 μm as a core, and about 20 μm as an overcladding. As an optical circuit element targeted by the present invention, a PLC formed on a Si substrate having such a size is assumed. In addition, the optical circuit element of Si photonics is assumed to have a structure in which SiO₂ forming an SOI layer as an undercladding is deposited on a Si substrate by several micrometers, Si as a core is deposited by several hundred nanometers, and SiO₂ as an overcladding is deposited by several micrometers. Furthermore, in general, an optical functional element using InP as a substrate has a structure in which an InP substrate is used as an undercladding, a compound semiconductor is deposited with several hundred nanometers as a core, InP is deposited as an overcladding, SiN or SiO₂ is deposited as passivation, and a metal pattern serving as an electrode is provided on a front surface or a back surface. The optical functional element targeted by the present invention is also assumed to be an optical functional element based on an InP substrate having such a size. In the present invention, the waveguide formed on the end face of the substrate of the optical functional element and the optical circuit element having such a structure and size is assumed as an input/output waveguide that inputs and outputs an optical signal. Thus, the waveguides need to be optically coupled with alignment accuracy of about 1/10 of the mode field on the end face.

The reflectance control bodies of the alignment input/output structure of the present embodiment described above can be formed, for example, by providing grooves in portions including claddings (including undercladding and overcladding) and passivation on both sides of a core constituting the input/output waveguide of the connection end face of the optical functional element. By filling the grooves with a material having a refractive index different from refractive indexes of the substrate, the core, and the cladding, the reflectance can be controlled. A depth of the grooves is desirably set not to be too far from a bottom surface of the core so that the core position can be easily determined from the reflected return light intensity profile. For example, the depth of the grooves is desirably about twice a distance from the substrate surface to the bottom surface of the core. In addition, a width (dimension in the X direction) of the grooves may be a size that causes a change in the reflected return light intensity. However, if the width is too large, scanning takes time. Thus, the width is desirably about the same as a distance in the X direction from the center of the core to the core-side end faces of the grooves. The distance in the X direction between the center of the core and the core-side wall surfaces of the grooves is desirably as small as possible within a range that does not affect the mode field of the core so that the core position can be easily determined from the reflected return light intensity profile. Furthermore, in order to facilitate estimation of the core position, it is desirable that the grooves are arranged symmetrically with respect to the core.

An antireflection film for reducing return light due to end face reflection is generally provided on a connection end face of the optical functional element to which the optical circuit element is to be connected. The antireflection film is designed in accordance with the refractive indexes of the core and the cladding and a fixing adhesive to be used for the connection end face, and thus, the intensity of the reflected return light from the portion corresponding to the core and the cladding of the connection end face is small. On the other hand, the refractive index of the reflectance control bodies is greatly different from the refractive indexes of the core and the cladding, and thus, the intensity of the reflected return light from the portions corresponding to the reflectance control bodies is larger than that of the portions corresponding to the core and the cladding. As described above, portions where the intensity of the reflected return light from the positions of the reflectance control bodies is large can be used as marks, and thus, it is desirable to provide the reflectance control bodies in the vicinity of the core in order to estimate the core position from the reflected return light intensity profile. As described above, the reflectance control bodies can be easily formed, for example, by forming grooves in the cladding and filling the grooves with a resin having a refractive index of about 1.5. On the other hand, in a case where a difference in refractive index between the resin and the core or the cladding is small, by forming only the grooves without filling the grooves with the resin, wall surfaces of the grooves can be used as reflection surfaces by the difference in refractive index between the groove end faces and air, and the grooves can function as reflectance control bodies. In a case where an ultraviolet curable resin, or the like, is used as the adhesive for the connection end face, alignment may be performed by filling a space between the connection end faces with an adhesive. In this event, if the grooves are formed up to the connection end face, the grooves may be filled with an adhesive, or the like, to be used for fixing the connection end face, which may make it impossible for the grooves to function as the reflection control units. In order to prevent such a situation from occurring, in a case where the reflectance control bodies are formed only with the grooves, it is desirable to form a groove offset from the connection end face. In addition, in a case where the reflectance control bodies are formed only with the grooves, it is desirable that the wall surfaces of the grooves on the connection end face side that become reflection surfaces be formed in parallel with the connection end face.

In the present embodiment, even in the U-shaped waveguide layout in which the input/output units of the optical functional element are on the same connection face, it is possible to adjust deviation of the Z-axis rotation in advance by acquiring the reflected return light intensity profiles of the input side and the output side and estimating the core position by the reflected return light intensity profiles.

As described above, in the integrated optical device in which the optical functional element that is provided on the substrate and perform optical signal processing, and the optical circuit element are hybrid-integrated, the reflected return light profile from the end face exhibits large contrast of the reflected light intensity at the end face structure boundary portion by device of providing the reflectance control bodies in the vicinity of the input/output waveguide as the alignment input/output structure of the optical functional element, so that the core position can be easily estimated without an alignment port being provided, and alignment can be efficiently performed in butt-coupling, which makes it possible to provide the integrated optical device obtained by simple optical butt-coupling.

### Example 1

Example 1 is an integrated optical device including an optical circuit element including a Sip chip including signal light input and signal light output optical waveguides and input/output optical waveguides for butt-coupling corresponding to the signal light input and signal light output optical waveguides, and an optical functional element including an InP chip including an alignment input/output structure including input/output waveguides for an optical signal to be butt-coupled with the input/output optical waveguides for butt-coupling of the optical circuit element.

Examples of such an integrated optical device can include an integrated optical modulation device illustrated in FIG. 5 as an embodiment of the present invention. This integrated optical modulation device includes a phase modulation waveguide that changes a phase of light by an electrical signal and optical waveguides for butt-coupling and uses, as an optical functional element, an optical modulation element in which the input/output waveguides for an optical signal are disposed on one end face by U-shaped optical waveguide arrangement. The light input to the input waveguide of the optical circuit element is optically coupled to the optical modulation element side via the butt-coupling portion, then converted into an optical signal phase-modulated by the phase modulation waveguide, again optically coupled to the optical circuit element via the butt-coupling portion, then subjected to polarization synthesis by the polarization rotator and the polarization beam combiner, and output.

Here, as a connection test device, an integrated optical device was configured to include an optical functional element including a U-shaped folded waveguide obtained by removing a phase modulation unit from such an integrated optical modulation device, and an optical circuit element including signal light input/output waveguides obtained by removing a polarization rotator and a polarization beam combiner, and input/output waveguides for butt-coupling. Then, alignment of the butt-coupling of the optical functional element and the optical circuit element of the integrated optical device was performed by preparing a device having an alignment input/output structure including reflectance control bodies as Example 1 and a device having no reflectance control body as Comparative Example, and measuring the reflected return light intensity profiles from the connection end faces of these devices.

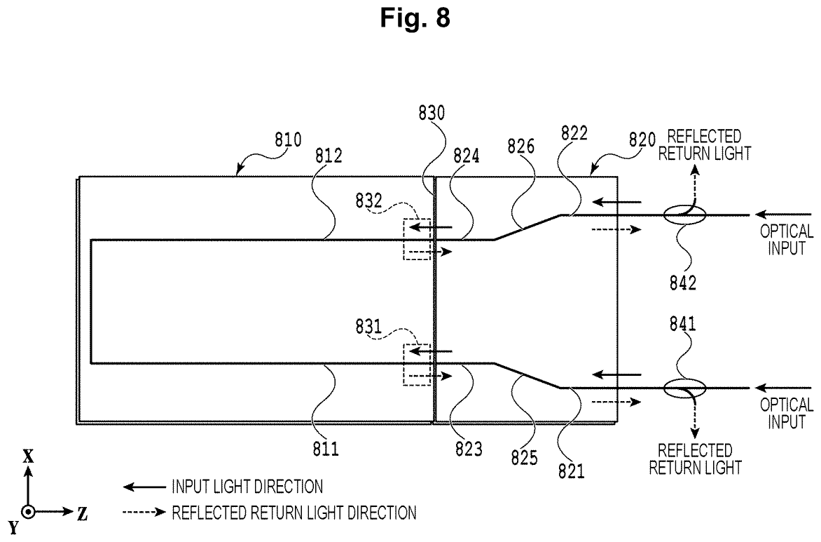

FIG. 8 is a view illustrating optical circuit configurations of integrated optical devices of Example 1 and Comparative Example 1. As a platform, an optical circuit element 820 is a Si photonic chip in which a SiO₂ undercladding having a size of 2.5 mm in length, 2.0 mm in width, and 0.6295 mm in thickness and having a thickness of 3.0 um, a Si core having a thickness of 0.22 μm and a width of 0.5 μm, and a SiO₂ overcladding having a thickness of 1.5 μm are formed on a Si substrate having a thickness of 0.625 mm.

Signal light of the optical circuit element 820 is input/output from one long side, and the opposite long side is connected to the optical functional element. The connection end face is polished for connection with the optical functional element. The optical circuit element 820 is provided with a signal light input waveguide 821 and a signal light output waveguide 822, and an input waveguide for butt-coupling 823 and an output waveguide for butt-coupling 824 as input/output waveguides for butt-coupling.

In addition, S-shaped waveguide structures 825, 826 are provided between the signal light input waveguide 821 and the input waveguide for butt-coupling 823 and between the signal light output waveguide 822 and the output waveguide for butt-coupling 824, respectively. With this S-shaped optical waveguide structure, the optical axes of the signal light input waveguide 821 and the input waveguide for butt-coupling 823 and the optical axes of the signal light output waveguide 822 and the output waveguide for butt-coupling 824 are shifted, which can prevent stray light, and the like.

An optical functional element 810 to be butt-coupled to the optical circuit element 820 is an InP chip having a size of 2.5 mm in length, 4.0 mm in width, and 0.25 mm in substrate thickness, including an InP substrate as an undercladding, a compound semiconductor core having a width of 2.0 μm and a thickness of 0.3 μm, and InP deposited as an overcladding with a film thickness of 2.0 μm.

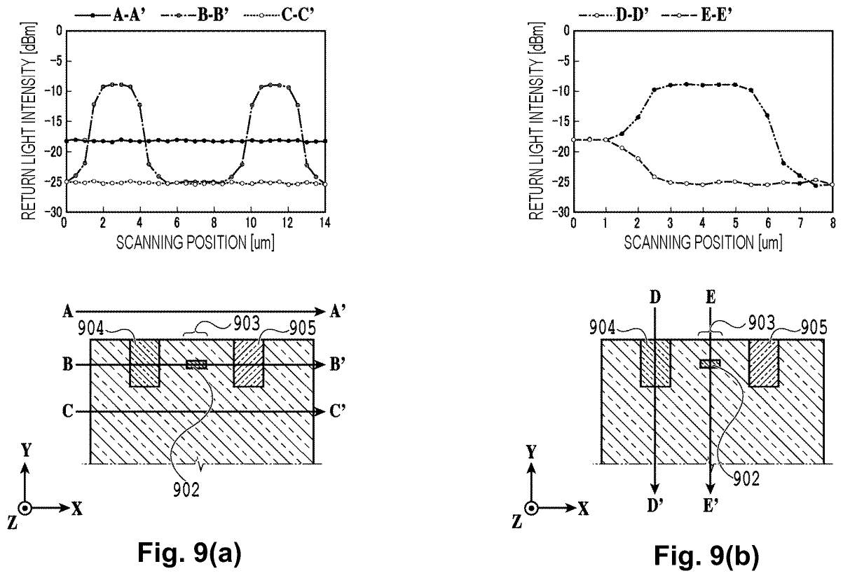

An optical input waveguide 811 and an optical output waveguide 812 are provided as input/output waveguides to be butt-coupled to the input/output waveguides for butt-coupling of the optical circuit element on one of the short sides of the optical functional element 810. The input/output waveguides including the optical input waveguide 811 and the optical output waveguide 812 have a U-shape, and an optical signal propagates from the optical input waveguide 811 to the optical output waveguide 812. Alignment input/output structures 831 and 832 are provided in the vicinity of the optical input waveguide 811 and the optical output waveguide 812 on a connection end face 830 which is one end face of the optical functional element 810. As illustrated in FIG. 9, in the alignment input/output structures 831 and 832, reflectance control bodies configured by grooves 904 and 905 filled with a resin having a refractive index of 1.5 are provided on both sides of each waveguide. The reflectance control bodies form regions having a reflectance different from reflectances of the core 902, the cladding, and the substrate when light is incident on the connection end face. The grooves are formed deeper than the bottom surface of the core 902 by 2 μm, a distance from the center of the core to the groove wall surfaces is 3 μm, and the groove width is 2 μm. Note that the dimensions of the above-described components for the optical functional element and the optical circuit element are indicated for the sake of illustration and may be other dimensions.

FIG. 9 is a view illustrating a relationship between a scanning position of the connection end face of the alignment input/output structure of the optical functional element of Example 1 and the reflected return light intensity profile corresponding to the scanning position. FIG. 9(a) illustrates X scanning, and FIG. 9(b) illustrates Y scanning.

The lower views of FIG. 9(a) and 9(b) illustrate the structure and each scanning position of the alignment input/output structures 831 and 832 provided in the vicinity of the optical input waveguide 821 and the optical output waveguide 822, which are the input/output waveguides of the optical functional element of Example 1, as viewed from the connection end face side.

In the alignment input/output structure of Example 2, reflectance control bodies including grooves 904 and 905 filled with a resin on both sides of a core 902 constituting regions where light of the input/output waveguide propagates and a core 902 of a waveguide region 903 including a cladding layer around the core are formed. The grooves 904 and 905 are formed in the same manner as the reflectance control bodies of the alignment output structure of the embodiment illustrated in FIG. 6.

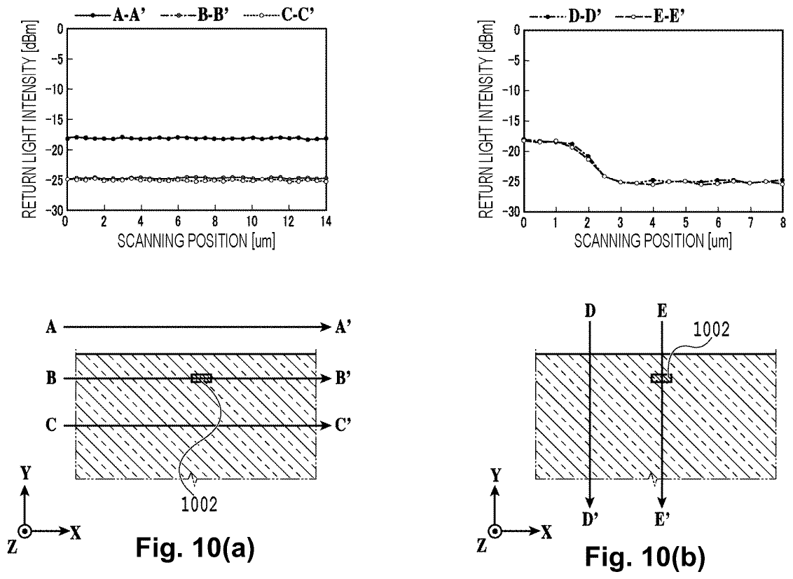

FIG. 10 is a view illustrating a relationship between a scanning position of a connection end face of an input/output unit of the optical functional element of Comparative Example 1 and a reflected return light intensity profile corresponding to the scanning position. For comparison with Example 1, Comparative Example 1 is an integrated circuit device in which an optical functional element and an optical circuit element having the same structure as that of Example 1 are connected, and a reflectance control body is not provided. FIG. 10(a) and 10(b) illustrate a scanning position and a reflected return light intensity profile corresponding to the scanning position for X scanning and Y scanning, respectively, similarly to FIG. 9. The lower structural views of FIG. 10(a) and 10(b) illustrate structures of the optical functional element of Comparative Example 1 as viewed from the connection end face side in the vicinity of the optical input waveguide and the optical output waveguide. In FIG. 10(a) and 10(b), the reflectance control bodies are not formed on both sides of the core 1002.

### (Acquisition of Reflected Return Light Intensity Profile for Pre-Alignment)

Next, a method for executing pre-alignment to be performed for butt-coupling between the input/output waveguides of the optical functional element and the waveguides of the optical circuit element will be described using Example 1. In the integrated circuit device of Example 1, for pre-alignment on the input side, as illustrated in FIG. 8, light having a wavelength of 1.55 μm was input from the signal light input waveguide 821 of the optical circuit element 820 via a circulator 841, the optical circuit element was scanned in the X and Y directions while acquiring the reflected return light intensity, and the reflected return light intensity profile from the connection end face on the input side of the optical functional element was acquired. Similarly, for pre-alignment on the output side, light was input from the signal light output waveguide 822 of the optical circuit element via a circulator 842, and reflected return light intensity was acquired, so that a reflected return light intensity profile of the connection end face on the output side of the optical functional element was also acquired.

In the optical functional element of Example 1, the intensity of the reflected return light is large in regions where the reflectance control bodies are formed. Thus, in the reflected return light intensity profile of X scanning in FIG. 9(a), two peaks corresponding to the reflectance control bodies are generated in the reflected return light intensity profile BB′ when a line B-B′ is scanned. The scanning positions of the two peaks and the positions of the reflectance control bodies are associated with each other, and thus, the positions of the reflectance control bodies can be estimated by the return light intensity profile. Then, from a relationship between the scanning position and the core 902 and the grooves 904 and 905 illustrated in the lower view, it can be estimated that the core is present between the scanning positions of the two peaks corresponding to the positions of the reflectance control bodies. Next, referring to the return light intensity profile of Y scanning in FIG. 9(b), one peak corresponding to the reflectance control body occurs in the reflected return light intensity profile DD′ when scanning is performed on a line D-D′. The scanning position of the peak is associated with the position of the reflectance control body, and thus, the position of the reflectance control body can be estimated. Then, from a positional relationship between the core 902 and the groove 904 illustrated in the structural drawing, it can be estimated that the core is at the peak center of the reflected return light intensity profile DD′.

In Example 1, the position of the core is estimated on the basis of the position of the reflectance control body estimated using the reflected return light intensity profile of the connection end face of the optical functional element. Then, on the basis of the estimated position of the core, positional deviation of the input/output waveguides for butt-coupling of the optical circuit element to be butt-coupled to the input waveguide and the output waveguide of the optical functional element is corrected, and thereby pre-alignment is completed. In this event, deviation of the Z-axis rotation can be obtained on the basis of the relationship between the core position and the scanning coordinate estimated from the reflected return light intensity profiles on the input waveguide side and the output waveguide side.

On the other hand, in the optical functional element of Comparative Example, the alignment input/output structure including the reflectance control body is not provided, and thus, even if the reflected return light intensity profile is acquired in the same manner as in Example 1, the reflected return light intensity profile BB′ obtained by scanning the line B-B′ of the return light intensity profile of X scanning in FIG. 10(a) and the reflected return light intensity profile CC′ obtained by scanning the line C-C′ are substantially the same. Thus, in Comparative Example 1 in which the reflectance control body is absent, it is not possible to determine the position (on the line B-B′ or the line C-C′) on the end face X at which scanning was performed depending on the reflected return light intensity profile of scanning in the X direction as in Example 1. In addition, there is no peak in the reflected return light intensity profile as in Example 1, and thus, the core position cannot be estimated. In addition, according to the return light intensity profile of Y scanning in FIG. 10(b), the reflected return light intensity profile DD′ scanned on the line D-D′ and the reflected return light intensity profile EE′ scanned on the line E-E′ are substantially the same. It is therefore not possible to determine the position (on the line D-D′ or the line E-E′) on the end face at which Y scanning was performed even by the return light intensity profile of Y scanning. Note that as described above, the antireflection film is provided on the connection end face of the optical functional element, the reflectance of the connection end face is smaller than that of air, and the reflected return light intensity changes at the boundary between the overcladding and air. Thus, the core position can be roughly estimated by estimating the scanning position in the Y direction where the reflected return light intensity changes as the boundary position between the overcladding and air and using the position as a reference. However, a difference in the reflected return light intensity between air and the overcladding is small, and the intensity of the reflected return light gradually changes, and thus, it is difficult to accurately estimate the core position. In particular, in a pre-alignment stage, a connection adhesive to be used for fixing the connection end faces of the optical functional element and the optical circuit element is often not introduced. In that case, the reflectance of the connection end face including the antireflection film designed on the premise of the presence of the connection adhesive is high, and the difference in reflected return light intensity between air and the overcladding is small.

As described above, if the integrated circuit device in which the input/output waveguides of the optical circuit element and the input/output waveguides of the optical functional element are butt-coupled is configured using the optical functional element having the alignment input/output structure including the reflectance control bodies and the input/output waveguides of Example 1, it is possible to easily perform pre-alignment on the basis of a relationship between the core position estimated on the basis of the reflected return light intensity profile and the scanning coordinate, to accurately perform pre-alignment without providing an alignment port, and to provide an integrated optical device obtained by simple optical butt-coupling.

### Example 2

Example 2 is an integrated optical device including an optical circuit element including a SiP chip including the same signal light input and signal light output optical waveguides as in Example 1 and input/output optical waveguides for butt-coupling corresponding to the signal light input and signal light output optical waveguides, and an optical functional element including an InP chip including an alignment input/output structure including input/output optical waveguides for an optical signal to be butt-coupled with the input/output optical waveguides for butt-coupling of the optical circuit element. In Example 2, instead of the reflectance control bodies of the alignment input/output structure O Example 1, reflectance control bodies including a plurality of grooves having different lengths formed side by side along a light propagation direction of the waveguide is provided on both sides of the core of the waveguide. Structures, sizes, and the like, of the optical circuit element and the optical functional element of the integrated optical device of Example 2 are the same as those of Example 1 except for the reflectance control body.

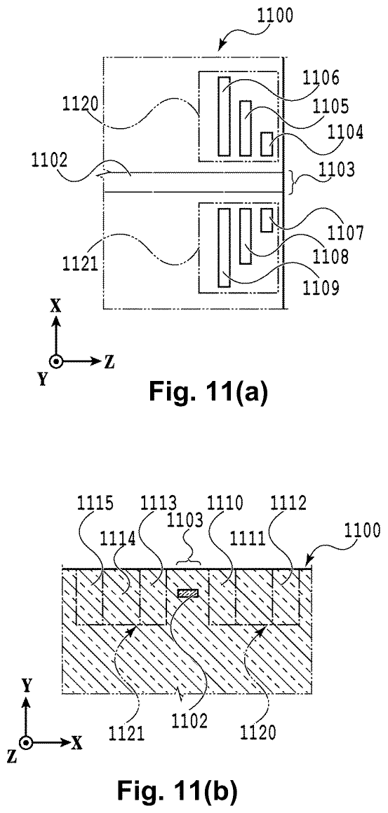

FIG. 11 is a view illustrating an alignment input/output structure of Example 2. FIG. 11(a) is a view of an alignment input/output structure 1100 as viewed from above, and FIG. 11(b) is a view of the alignment input/output structure 1100 as viewed from the connection end face side. The alignment input/output structure of Example 2 includes reflectance control bodies including a plurality of grooves arranged along the light propagation direction of the waveguide constituted by waveguide regions on both sides of a core 1102 of a waveguide region 1103 constituted by the core 1102 constituting the region through which light propagates and the cladding layer around the core. In the alignment input/output structure illustrated for illustration in FIG. 11, three grooves 1104, three grooves 1105, three grooves 1106, three grooves 1107, three grooves 1108, and three grooves 1109 are formed on both sides of the core of the waveguide, and widths of the three grooves, which are dimensions in a direction (X direction in the drawing) parallel to the upper surface and the connection end face of the substrate, are different from each other. The bottom surface of each groove is formed deeper than the bottom surface of the core 1102 by 2 μm, the distance from the center of the core to the wall surface of each groove on the core side is 2 μm, and the length, which is the dimension in the Z direction, is 1.5 μm. The width of each groove is 2 μm, 4 μm, and 6 μm from the side closer to the end face. Note that the dimensions of the above-described components of the optical functional element and the optical circuit element of the integrated optical device of Example 2 are indicated for the sake of illustration and may be other dimensions.

Each of the grooves is formed at a position away from the connection end face (offset from the connection end face) so that none of the grooves reaches the end face. The grooves constituting the reflectance control bodies of Example 2 are not filled with the resin as in Example 1, and thus, interfaces between the substrate material and air are formed on the wall surfaces of the grooves. The wall surface of the groove on a side closer to the connection end face of each groove serves as a reflection surface, and light applied to the connection end face is reflected by the wall surface of the groove and becomes reflected return light. The wall surface of each groove constituting the reflection surface on a side close to the connection end face is desirably formed in parallel with the connection end face. The reflected return light intensity increases when the position of the groove is closer to the connection end face because the connection end face and the reflection surface are closer to each other, and the reflected return light intensity decreases when the position of the groove is farther from the connection end face. Thus, as illustrated in FIG. 11(b), on the end face of the input/output unit, a reflectance control body 1120 including a region 1110, a region 1111, and a region 1112 having different reflectances, and a reflectance control body 1121 including a region 1113, a region 1114, and a region 1115 having different reflectances are formed on both sides of the core.

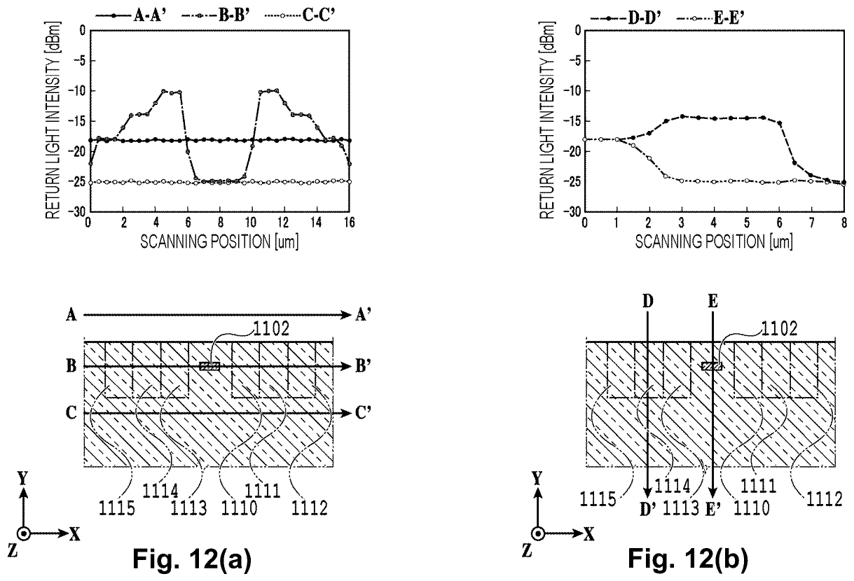

FIG. 12 is a view illustrating a relationship between the scanning position of the connection end face of the alignment input/output structure of the optical functional element of Example 2 and the reflected return light intensity profile corresponding to the scanning position. FIG. 12 illustrates a reflected return light intensity profile of Example 2 obtained by the same method as in Example 1. FIG. 12(a) illustrates X scanning, and FIG. 12(b) illustrates Y scanning. From the reflected return light intensity profile in FIG. 12(a), it can be estimated that there is a core between two peaks of BB′ of the reflected return light intensity profile of X scanning according to Example 2 as in Example 1. From the reflected return light intensity profile of FIG. 12(b), it can be estimated that there is a core at the center of the peak of DD′ in the reflected return light intensity profile of scanning in the Y direction.

As described above, in the reflectance control bodies of Example 2, three regions having different reflectances are formed, the reflectances of the region 1110 and the region 1113 close to the core are the largest, and the reflectance decreases in the order of the region 1111 and the region 1114, the region 1112, and the region 1115.

In a case where scanning is performed on the line B-B′ of X scanning in FIG. 12(a), scanning is sequentially performed on each region. Thus, if the reflected return light intensity profile BB′ is viewed, the reflected return light intensity has a profile of steeply rising from the center of the estimated core toward the outside and then gradually decreasing stepwise. By using the shapes of two peaks of the reflected return light intensity profile, it is easier to grasp the scanning position in Example 2 than in Example 1.

In Example 1, the two peaks of the reflected return light intensity profile of X scanning are both symmetrical in shape. Thus, in a case where the reflected return light intensity is acquired at the first scanning position, and then the reflected return light intensity acquired while sliding the scanning position in the right direction decreases, it is not possible to determine whether the scanning position is close to the core (at the position corresponding to the left peak position) or distant from the core (at the position corresponding to the left peak position). Thus, in Example 1, it is necessary to acquire and confirm the reflected return light intensity profile by greatly sliding the scanning position, and it takes time to confirm the scanning position.

On the other hand, in Example 2, in a case where the reflected return light intensity is acquired at the first scanning position and then the reflected return light intensity acquired while sliding the scanning position in the right direction rapidly decreases, it can be determined that the scanning position is close to the core (at a position corresponding to the left peak). Then, in a case where the reflected return light intensity gradually decreases stepwise, it can be determined that the scanning position is moving away from the core (at a position corresponding to the right peak).

Each groove constituting the reflectance control body of Example 2 is formed at a position away from the connection end face (offset from the connection end face) and is formed so that none of the grooves reaches the end face. For this reason, the grooves of Example 2 have a structure in which an adhesive such as an ultraviolet curing resin to be used for fixing the connection end face hardly flows into the grooves. As described above, in a case where an ultraviolet curable resin, or the like, is used as the adhesive of the connection end face, alignment may be performed after a space between the connection end faces is filled with the adhesive in advance. Even in such a case, it is possible to prevent a situation where a clear reflected return light profile cannot be obtained as a result of the adhesive flowing into the grooves and the refractive index difference between the end faces of the grooves and a medium inside the grooves becoming small.

As described above, by measuring the profile of the reflected return light in butt-coupling with the optical circuit element by the optical functional element provided with the alignment input/output structure including the reflectance control bodies and the input/output waveguides of Example 2, it is possible to perform pre-alignment with high accuracy without providing an alignment port, and it is possible to provide the integrated optical device obtained by simple optical butt-coupling.

### Example 3

Example 3 is an integrated optical device including an optical circuit element including a SiP chip including the same signal light input and signal light output optical waveguides as in Example 1 and input/output optical waveguides for butt-coupling corresponding to the signal light input and signal light output optical waveguides, and an optical functional element including an InP chip including an alignment input/output structure including input/output waveguides to be butt-coupled with the input/output optical waveguides for butt-coupling of the optical circuit element. In Example 3, instead of the reflectance control bodies of the alignment input/output structure of Example 1, reflectance control bodies including grooves having a plurality of bottom surfaces having different depths are provided on both sides of the core of the input/output waveguide. Structures, sizes, and the like, of the optical circuit element and the optical functional element of the integrated optical device of Example 3 are the same as those of Example 1 except for the reflectance control bodies.

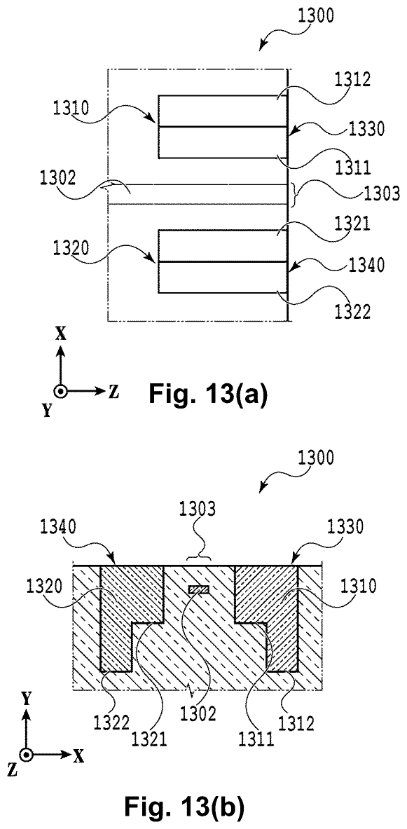

FIG. 13 is a view illustrating an alignment input/output structure of Example 3. FIG. 13(a) is a view of an alignment input/output structure 1300 as viewed from above, and FIG. 13(b) is a view of the alignment input/output structure 1300 as viewed from the connection end face side.

The alignment input/output structure of Example 3 includes a reflectance control body 1330 including a groove 1310 and a reflectance control body 1340 including a groove 1320 on both sides of a core 1302 of a waveguide region 1303 including a core 1302 constituting a region through which light propagates and a cladding layer around the core. The reflectance control bodies form regions having a reflectance different from reflectances of the core, the cladding, and the substrate when light is incident on the connection end face.

In the alignment input/output structure illustrated as an example in FIG. 13, the grooves 1310 on both sides of the waveguide include bottom surfaces 1311 and 1312 having two different depths, and the grooves 1320 include bottom surfaces 1321 and 1322 having two different depths. In each of the grooves 1310 and 1320, a distance from the center of the core to the wall surface of the groove on the core side is 2 μm, and a length of the groove is 5 μm. Further, the bottom surfaces of the grooves 1310 and 1320 include a surface deeper than the bottom surface of the core by 2 μm and a surface deeper than the bottom surface of the core by 6 μm, and the bottom surfaces at the respective depths are each formed to have a width of 2 μm. Note that the dimensions of the above-described components of the optical functional element and the optical circuit element of the integrated optical device of Example 3 are indicated for the sake of illustration, and may be other dimensions.

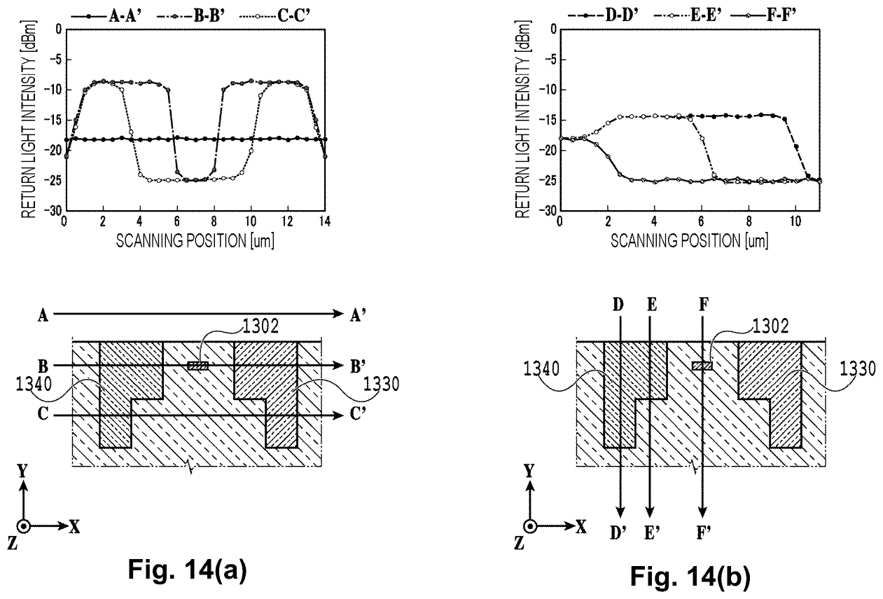

FIG. 14 illustrates a scanning position of the connection end face of the alignment input/output structure of the optical functional element of Example 3 and a reflected return light intensity profile corresponding to the scanning position. Also in Example 3, the reflected return light intensity profile was acquired in the same manner as in Example 1. FIG. 14(a) illustrates the reflected return light intensity profile of X scanning of Example 3, and FIG. 14(b) illustrates the reflected return light intensity profile of Y scanning of Example 3.

As described above, the reflectance control bodies of Example 3 are constituted by grooves having two bottom surfaces having different depths, as illustrated in FIG. 14(a), in the reflected return light intensity profile of X scanning, two peaks occur in the reflected return light intensity profile BB′ scanned on the line B-B′ and the reflected return light intensity profile CC′ scanned on the line C-C′. Thus, it can be estimated that there is a core between the two peaks of the reflected return light intensity profiles BB′ and CC′ in Example 3 as in Example 1. It can also be seen that the scanning position of the reflected return light intensity profile with a narrow interval between the peaks is the scanning position close to the corresponding core on the line B-B′. Then, in the reflected return light intensity profile of Y scanning, it can be estimated that there is a core at the center of the peak of EE′ having a narrow peak width from the difference in the peak width between the reflected return light intensity profile DD′ scanned on the line D-D′ and the reflected return light intensity profile EE′ scanned on the line E-E′. As described above, also in Example 3, the core position can be estimated using the reflected return light intensity profile in the same manner as in Example 1.

Furthermore, in Example 3, the grooves constituting the reflectance control bodies are configured to have bottom surfaces of a plurality of depths, and thus, the reflectance control bodies have a stepwise shape when viewed from the end face. Thus, in Example 3, the core position can also be estimated by boundary scanning in which the optical functional element or the optical circuit element is scanned while being shifted in the X-Y direction while the reflected return light intensity is acquired, and a portion where the reflected return light intensity greatly changes is found and traced.

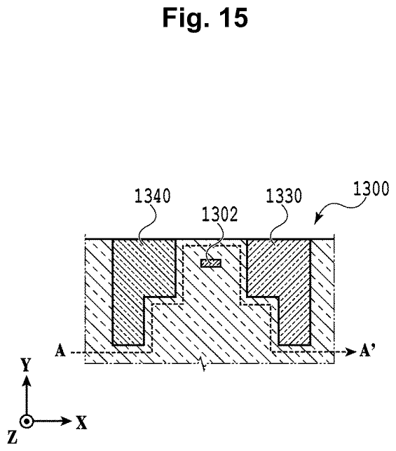

Hereinafter, this boundary scanning will be specifically described with reference to FIG. 15. In the alignment input/output structure 1300 of Example 3, portions where the reflected return light intensity greatly changes are any of a boundary portion between the reflectance control bodies 1330 and 1340 and the cladding and a boundary portion upper surface of the cladding portion including the core 1302 between the reflectance control body 1330 and the reflectance control body 1340 indicated by a dotted line A-A′ in FIG. 15. Thus, if portions where the reflected return light intensity greatly changes are sequentially traced on the connection end face of the alignment input/output structure, the dotted line A-A′ including the boundary of the reflectance control body can be traced as illustrated in FIG. 15. From the result of tracing the boundary portions where the reflected return light intensity greatly changes, a positional relationship between the cross-sectional shape of the alignment input/output structure and the scanning coordinates can be associated, and the core position can be estimated from the positional relationship.

Example 3 has the following advantages as compared with the case where the reflectance control bodies have a rectangular shape as in Example 1 or Example 2 because the reflectance control bodies of Example 3 have a characteristic cross-sectional shape including two or more steps by a plurality of bottom surfaces having different depths. Even in a case where there is another reflection structure on the chip, the shape of the reflectance control body is characteristic, and thus, it is a clue to confirm that a portion scanned in a distinguished manner from the other reflection structures is the reflectance control body. In addition, it is possible to more easily estimate which portion of the reflectance control body is traced in the trace of the boundary portion where the reflected return light intensity greatly changes than in the rectangular shape as in Example 1 or Example 2.

As described above, in a case where the reflectance control bodies of Example 3 are used, not only the core position is estimated by repeating X scanning and Y scanning as in Example 1, but also the cross-sectional shape is estimated by tracing the boundary at which the reflected return light intensity greatly changes by the boundary scanning only once, whereby the core position can be estimated.

As described above, by measuring the profile of the reflected return light in butt-coupling with the optical circuit element using the optical functional element provided with the alignment input/output structure including the reflectance control bodies and the input/output waveguides of Example 3, it is possible to perform pre-alignment with high accuracy without providing an alignment port, and it is possible to provide the integrated optical device obtained by simple optical butt-coupling.

### INDUSTRIAL APPLICABILITY

The present invention can be used in an integrated optical device applicable to an optical communication system. In particular, the present invention relates to an integrated optical device in which input/output waveguides of an optical functional element including optical waveguides and input/output waveguides of an optical circuit element are butt-coupled by performing alignment and bonding.

1. An integrated optical device comprising an optical functional element in which an optical waveguide including a core and a cladding is provided on a substrate, the optical functional element comprising:
an input waveguide or an output waveguide of an optical signal provided on an end face of the substrate; and
a reflectance control body that is provided in the vicinity of the core and forms a region having a reflectance different from reflectances of the core, the cladding, and the substrate when light is incident on the end face,
wherein the input waveguide or the output waveguide of the optical functional element is butt-coupled and bonded to another waveguide via the end face.

2. The integrated optical device according to claim 1,
wherein a path through which light input from the input waveguide is output from the output waveguide is disposed,
the input waveguide and the output waveguide are provided on the end face, and
signal light is input/output from/to the optical functional element via the end face.

3. The integrated optical device according to claim 1,
wherein the substrate of the optical functional element is Si or InP, and
the other waveguide is provided on the Si substrate.

4. The integrated optical device according to claim 1,
wherein grooves having a depth equal to or greater than a bottom surface of the core are provided on both sides of the core as the reflectance control body, and the grooves are filled with a resin having a refractive index different from refractive indexes of the core, the cladding, and the substrate.

5. The integrated optical device according to claim 1,
wherein grooves having a depth equal to or greater than a bottom surface of the core are provided on both sides of the core as the reflectance control body, each of the grooves is formed without reaching the end face, and a wall surface on the end face side of each of the grooves is formed in parallel with the end face.

6. The integrated optical device according to claim 5,
wherein two or more of the grooves are provided on both sides of the core as the reflectance control body.

7. The integrated optical device according to claim 1,
wherein grooves having a depth equal to or greater than a depth of a bottom surface of the core is provided on both sides of the core as the reflectance control body, and each of the grooves has a plurality of bottom surfaces having different depths.

8. An alignment method for an integrated optical device including an optical functional element in which an optical waveguide including a core and a cladding is provided on a substrate, and the optical functional element comprising:
an input waveguide or an output waveguide of an optical signal provided on an end face of the substrate; and
a reflectance control body that is provided in the vicinity of the core and forms a region having a reflectance different from reflectances of the core, the cladding, and the substrate when light is incident on the end face,
the alignment method comprising:
in alignment for butt-coupling via the end face between the optical functional element and an optical circuit element comprising an input waveguide or an output waveguide for connection,
monitoring light intensity of reflected return light branched by a circulator or a coupler disposed at an optical input of the optical circuit element; and
performing alignment by estimating correspondence between a scanning position and a position of the region having different reflectance formed by the reflectance control body on the end face from a position at which a profile of the light intensity of the reflected return light in accordance with a cross-sectional shape of the end face becomes a peak by performing scanning while moving the optical functional element or the optical circuit element.

9. The integrated optical device according to claim 2,
wherein the substrate of the optical functional element is Si or InP, and
the other waveguide is provided on the Si substrate.

10. The integrated optical device according to claim 2,
wherein grooves having a depth equal to or greater than a bottom surface of the core are provided on both sides of the core as the reflectance control body, and the grooves are filled with a resin having a refractive index different from refractive indexes of the core, the cladding, and the substrate.

11. The integrated optical device according to claim 2,
wherein grooves having a depth equal to or greater than a bottom surface of the core are provided on both sides of the core as the reflectance control body, each of the grooves is formed without reaching the end face, and a wall surface on the end face side of each of the grooves is formed in parallel with the end face.

12. The integrated optical device according to claim 2,
wherein grooves having a depth equal to or greater than a depth of a bottom surface of the core is provided on both sides of the core as the reflectance control body, and each of the grooves has a plurality of bottom surfaces having different depths.
